(19) United States
(12) Patent Application Publication
(10) Pub. No.: US 2006/0011096 A1
(43) Pub. Date: Jan. 19, 2006

(54) Producing method for ink for inkjet recording

(75) Inventor: Yutaka Sakasai, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/182,768

(22) Filed: Jul. 18, 2005

(30) Foreign Application Priority Data
Jul. 16, 2004 (JP) P.2004-209822

(51) Int. Cl. C09D 11/00

(52) U.S. Cl. 106/31.27

(57) ABSTRACT

A method for producing an ink for inkjet recording is provided and includes subjecting at least a resin and a colorant in succession to a step of melt-kneading, a step of crushing and a step of wet dispersing in a dispersion medium, in which colorant-resin particles obtained in the crushing step are stored in an external environment with an absolute humidity of 4 to 35 g/m³ and are subjected to a wet dispersion in a dispersion medium.

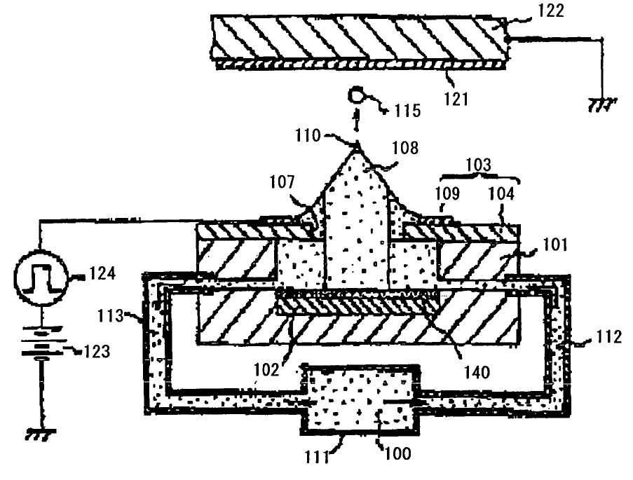

### FIELD OF THE INVENTION

The present invention relates to a producing method for an ink for inkjet recording, and more particularly an oily ink for use in an electrostatic inkjet recording apparatus to cause an ink to fly thereby forming a character or an image on a transfer medium such as a recording paper, and a producing method therefor.

### BACKGROUND OF THE INVENTION

An inkjet recording method for executing a printing by causing an ink to fly to a recording medium thereby forming a recording dot is attracting attention as a non-impact recording method capable of easy formation of a color image and of direct recording on a plain paper, and is commercialized in various printers. The inkjet recording method is described in known literatures such as Takeshi Agui et al., “Real Color Hard Copy”, published by Sangyo Tosho Co. (1993), Shin Ohno, “Non-impact printing, Technology and Materials”, published by CMC Co. (1986), and Takeshi Amari, “Inkjet printer, Technology and Materials”, published by CMC Co. (1998), and includes an on-demand method (an on-demand discharge method) and a continuous method (a continuous discharge method). Also the continuous method is known for example in an electrostatic type (Sweet type or Hertz type), and the on-demand method is known for example in a piezoelectric type, a shear mode piezoelectric type, and a type called a thermal inkjet method.

An ink for inkjet recording can generally be formed by forming colorant particles (colored mixture), prepared by coating a colorant with a resin insoluble in a dispersion medium for example by a melt-kneading followed by a crushing, and dispersing such colored mixture in a dispersion medium containing a dispersant into fine particles (wet dispersion). The dispersion step can be performed with a commercially available wet dispersion equipment, such as a ball mill, a sand mill or an attritor.

As one of the on-demand inkjet recording methods, there is known a method called an electrostatic acceleration inkjet method or a slit jet method, described for example by Susumu Ichinose and Yuji Ohba, J. of IEICE, vol. J66-C (No. 1), p.47 (1983) and Tadayoshi Ohno and Mamoru Minaguchi, J. IIEEJ, vol. 10 (No. 3), p.157 (1981). In this method, a voltage is applied between plural recording electrodes positioned in an opposed relationship to a recording material and a counter electrode positioned behind the recording material, and a potential difference between both electrodes applies an electrostatic force on an ink supplied on the recording electrode thereby causing the ink to fly onto the recording medium, and specific modes of execution are described for example in JP-A Nos. 56-170, 56-4467 and 57-151374. This method employs, instead of nozzles in the prior inkjet head, an ink discharge port of an elongated slit shape having a plurality of recording electrodes on an internal wall, and an ink is supplied to such slit-shaped ink chamber while a high voltage is selectively applied to the electrodes to discharge the ink in the vicinity of the electrodes toward the recording paper positioned in a close opposed relationship to the slit thereby achieving a recording. This method has little concern on the ink clogging and can anticipate a reduction in the production cost because of a simple structure of the head, and is also effective for realizing a long-line head of a length capable of covering a wide range in the transversal direction of the recording medium.

A drop-on-demand type full-color recording head constructed with such electrostatic acceleration inkjet method is described for example in JP-B No. 60-59569 and J. of IEICE, vol. J68-C,2 (1985), pp.93-100.

In such electrostatic acceleration inkjet head, an oily ink formed by dissolving a dye in an organic solvent is employed advantageously, and, though materials constituting the ink are not disclosed in detail, there is employed for example an ink having a volume resistivity (electrical resistivity) of 10⁷ to 10⁸ Ω·cm, a surface tension of 22 mN/m and a viscosity of 3.1 to 6.9 cP.

However such oily ink, having a lower surface tension in comparison with an aqueous ink ordinarily employed in other inkjet methods, shows a very large penetrability into the recording paper, thus often resulting in a lowered print density, an image blotting or a transfer to another stacked paper particularly in case of a printing on a plain paper.

On the other hand, an electrostatic inkjet method of a colorant concentrating discharge type, not employing such slit-shaped recording head, is disclosed in JP-A No. 9-193389 and JP-A No. 10-138493. In this method, plural individual electrodes for applying an electrostatic force on a colorant component in the ink includes a control electrode substrate formed by an insulating substrate having penetrating holes and control electrodes formed corresponding to such penetrating holes, and convex ink guides positioned at approximate centers of the penetrating holes, in which the ink is brought to an ink droplet flying position along the surface of the convex ink guide by a surface tension, and a voltage is applied to the control electrode to cause an ink droplet to fly to a recording medium thereby executing a recording.

In such electrostatic inkjet method of the colorant concentrating discharge type, the colorant particles are concentrated by an electrophoresis to a discharge port portion, and the ink droplet flies in a state where the colorant particles are concentrated to a high concentration. Therefore, different from the aforementioned methods, the ink is not discharged in a state containing the components of the ink uniformly with a large amount of a liquid component but discharged in a state in which the colorant particles are concentrated with a reduced amount of the liquid component, thereby resolving the aforementioned drawbacks. Also the use of a pigment as colorant provides advantageous results on a water resistance and a light fastness of the printed image, in comparison with the prior inkjet methods utilizing a dye.

In such electrostatic inkjet method of the colorant concentrating discharge type, in order to obtain satisfactory printing characteristics with a high print density and without a blotting or a transfer to another stacked paper, it is extremely important to control physical properties of the ink such as a particle size of the ink, a particle size distribution, an electroconductivity of the ink and an electroconductivity represented by the particles in the ink, a viscosity and a surface tension. Since it is necessary, in the ink for the electrostatic inkjet recording, to provide the colorant particles with a charge by adding a charge regulating agent thereto, it is particularly important to control the electroconductivity of the ink. An ink having an electrocondctivity within a range satisfying the discharge property can be obtained by maintaining a constant particle size at the wet dispersion under constant manufacturing conditions. It is however found that, even when the particle size is matched under same conditions of melt-kneading, crushing and wet dispersion, the electroconductivity of the ink shows a considerable fluctuation, thus failing to satisfy the discharge property.

### SUMMARY OF THE INVENTION

An object of an illustrative, non-limiting embodiment of the present invention is to provide a producing method for an ink for inkjet recording, capable of providing an ink showing a stable electroconductivity soon after the manufacturing and capable of providing a satisfactory reproducibility in repetition. Also it is to provide a producing method capable of providing a stable conductivity of the ink, thereby securing a stable discharge property constantly and enabling an image recording of a high image quality.

The present inventors have found, as a result of intensive investigations, that a producing method for an inkjet recording ink having a stable discharge property and capable of achieving an image recording of a high image quality can be realized by storing colorant-resin particles, obtained by a melt-kneading step and a crushing step, for a period under a specified external environment and executing a wet dispersion in a dispersion medium.

More specifically, the present invention is represented as follows:
(1) A method for producing an ink for inkjet recording by subjecting at least a resin and a colorant in succession to a step of melt-kneading, a step of crushing and a step of wet dispersing in a dispersion medium, wherein colorant-resin particles obtained in the crushing step are stored in an external environment with an absolute humidity of 4 to 35 g/m³ and are subjected to a wet dispersion in a dispersion medium.
That is, a method for producing an ink for inkjet recording, comprising: melt-kneading a resin and a colorant to provide a colored mixture (melt-kneading step); crushing the colored mixture to provide colorant-resin particles (crushing step); and wet dispersing the colorant-resin particles in a dispersion medium (wet dispersion step), wherein the method further comprises storing the colorant-resin particles in an external environment having an absolute humidity of 4 to 35 g/m³ before the wet dispersing of the colorant-resin particles (storage step).
(2) The method for producing an ink for inkjet recording described in (1), wherein, in the storing of the colorant-resin particles obtained in the crushing step, the external environment of the storage step has a variation of the absolute humidity within a range of ±3 g/m³, and the wet dispersing of the colorant-resin particles in the dispersion medium is performed after the storing of the colorant-resin particles in the external environment for at least 3 hours.

As the present invention allows to obtain an ink conductivity soon after the manufacturing and with satisfactory reproducibility, the ink can be used for discharge immediately after the manufacture. Also by attaining a stable elecctroconductivity in the ink, there can be provided a producing method for an inkjet recording ink capable of constantly securing a stable discharge property and of an image recording of a high image quality.

### BRIEF DESCRIPTION OF THE DRAWING

The sole FIGURE is a view showing an example of structure of a line-scan multi-channel inkjet head for use in an electrostatic inkjet recording method, and showing a cross section of a discharge electrode corresponding to a recording dot.

### DETAILED DESCRIPTION OF THE INVENTION

In the following, an exemplary embodiment of the present invention will be clarified in detail.

At first there will be explained components of an inkjet recording ink obtained by the present invention.

(Dispersion Medium)

A dispersion medium to be employed in the wet dispersion step of the invention is a non-polar insulating solvent, preferably having a specific dielectric constant of 1.5 to 20 and a surface tension of 15 to 60 mN/m (at 25° C.). Further preferred properties include a low toxicity, a low inflammability and a low odor.

Such dispersion medium can be a solvent selected from a linear or branched aliphatic hydrocarbon, an alicyclic hydrocarbon, an aromatic hydrocarbon, a petroleum naphtha and a halogen-substituted substance thereof. For example there can be employed hexane, octane, isooctane, decane, isodecane, decaline, nonane, dodecane, isododecane, Isopar-E, Isopar-G, Isopar-H or Isopar-L manufactured by Exxon Inc., Soltol manufactured by Philip Petroleum Inc., IP-solvent manufactured by Idemitsu Petrochemical Co., or a petroleum naphtha such as S.B.R. Shellsol-70 or Shellsol-71 manufactured by Shell Petrochemical Inc., or Vegasol manufactured by Mobile Oil Inc. either singly or in a mixture.

A preferred hydrocarbon solvent is a high-purity isoparaffin hydrocarbon having a boiling point within a range of 150 to 350° C., which can be, as a commercial product, Isopar G, H, L, M, V or Noper 12, 13 or 15 (trade name) of Exxon Inc., IP-solvent 1620 or 2028 (trade name) of Idemitsu Petrochemical Co., Isosol 300 or 400 (trade name) of Nippon Petrochemical Co., or Amsco OMS or 460 (trade name) of Spirits Inc. These products are extremely high-purity aliphatic saturated hydrocarbons having a viscosity at 25° C. of 3 cSt or less, a surface tension at 25° C. of 22.5 to 28.0 mN/m and a specific resistivity at 25° C. of 10¹⁰ Ω·cm or higher. Also they are stable with low reactivity, safe with a low toxicity and a low odor.

A halogen-substituted hydrocarbon solvent can be a fluorocarbon solvent, for example a perfluoroalkane represented by CₙF₂ₙ₊₂ such as C₇F₁₆ or C₈F₁₈ (such as Fluorinate PF5080 or Fluorinate PF5070 (trade name) manufactured by Sumitomo 3M Co.), a fluorinated inert liquid (such as Fluorinate FC series (trade name) manufactured by Sumitomo 3M Co.), a fluorocarbon (such as Clitox GPL series (trade name) manufactured by DuPont Japan Ltd.), or a flon (such as HCFC-141b (trade name) manufactured by Daikin Ltd.), an iodinated fluorocarbon such as (F(CF₂)₄CH₂CH₂I) or (F(CF₂)₆I) (such as I-1420 or I-1600 (trade name) manufactured by Daikin Fine Chemical Institute).

As a dispersion medium to be employed in the invention, there can also be employed a higher fatty acid ester or silicone oil. Specific examples of silicone oil include low-viscosity synthetic dimethylpolysiloxane, which can be, as a commercial product, KF96L (trade name) manufactured by Shin-etsu Silicone Co. or SH200 (trade name) manufactured by Toray Dow-Corning Silicone Co.

The silicone oil is not limited to such specific examples. Such dimethylsiloxane is available in a very wide viscosity range depending on a molecular weight thereof, but a range of 1 to 20 cSt is preferably employed. Such dimethylpolysiloxanes, like isoparaffin hydrocarbons, have a volume resistivity of 10¹⁰ Ω·cm or higher, and have features of a high stability, a high safety and a low odor. Also such dimethylpolysiloxanes are featured in a low surface tension of 18 to 21 mN/m.

A solvent that can employed in a mixture with such organic solvent can be an alcohol (such as methyl alcohol, ethyl alcohol, propyl alcohol, butyl alcohol or a fluorinated alcohol), a ketone (such as acetone, methyl ethyl ketone or cyclohexanone), a carboxylate ester (such as methyl acetate, ethyl acetate, propyl acetate, butyl acetate, methyl propionate or ethyl propionate), an ether (such as diethyl ether, dipropyl ether, tetrahydrofuran or dioxane), or a halogenated hydrocarbon (such as methylene dichloride, chloroform, carbon tetrachloride, dichloroethane or methylchloroform).

(Colorant)

In the following, there will be given a detailed description on the colorant.

The colorant is not particularly restricted, and any commercially available organic or inorganic pigment can be utilized.

For example, for providing yellow color, there can be conceived an azo pigment such as C.I. Pigment Yellow 1 (such as Fast Yellow G) or C.I. Pigment yellow 74, a disazo pigment such as C.I. Pigment Yellow 12 (such as Disazo Yellow AAA), or C.I. Pigment Yellow 17, a non-benzidine azo pigment such as C.I. Pigment Yellow 180, an azo lake pigment such as C.I. Pigment Yellow 100 (such as Tartrazine Yellow Lake), a condensed azo pigment such as C.I. Pigment Yellow 95 (such as Condensed Yellow GR), an acidic dye lake pigment such as C.I. Pigment Yellow 115 (for example Quinoline Yellow Lake), a basic dye lake pigment such as C.I. Pigment Yellow 18 (for example thioflavin lake), an anthraquinone pigment such as Flavanthrone Yellow (Y-24), an isoindolinone pigment such as Isoindolinone Yellow 3RLT (Y-110), a quinophthalone pigment such as Quinophthalone Yellow (Y-138), an isoindolinone pigment such as Isoindolinone Yellow (Y-139), a nitroso pigment such as C.I. Pigment Yellow 153 (for example Nickel Nitroso Yellow), or a metal complex salt azomethine pigment such as C.I. Pigment Yellow 117 (for example Copper Azomethine Yellow).

For providing magenta color, there can be conceived a monoazo pigment such as C.I. Pigment Red 3 (for example Toluidine Red), a disazo pigment such as C.I. Pigment Red 38 (for example Pyrazolone Red B), an azo lake pigment such as C.I. Pigment Red 53:1 (for example Lake Red C) or C.I. Pigment Red 57:1 (for example Brilliant Carmine 6B), a condensed azo pigment such as C.I. Pigment Red 144 (for example Condensed Azo Red BR), an acidic dye lake pigment such as C.I. Pigment Red 174 (for example Floxine B Lake), a basic dye lake pigment such as C.I. Pigment Red 81 (for example Rhodamine 6G' Lake), an anthraquinone pigment such as C.I. Pigment Red 177 (for example Dianthraquinonyl Red), a thioindigo pigment such as C.I. Pigment Red 88 (for example Thioindigo Bordeaux), a perynone pigment such as C.I. Pigment Red 194 (for example Porynone Red), a perylene pigment such as C.I. Pigment Red 149 (for example Perylene Scarlet), a quinacridone pigment such as C.I. Pigment Red 122 (for example Quinacridone Red), an isoindolinone pigment such as C.I. Pigment Red 180 (for example Isoindolinone Red 2BLT), or an alizarin lake pigment such as C.I. Pigment Red 83 (for example Madder Lake).

For providing cyan color, there can be conceived a disazo pigment such as C.I. Pigment Blue 25 (for example Dianisidine Blue), a phthalocyanine pigment such as C.I. Pigment Blue 15 (for example Phthalocyanine Blue), an acidic dye lake pigment such as C.I. Pigment Blue 24 (for example Peacock Blue Lake), a basic dye lake pigment such as C.I. Pigment Blue 1 (for example Bichrotia Pure Blue BO Lake), an anthraquinone pigment such as C.I. Pigment Blue 60 (for example Indanthrone Blue), or an alkali blue pigment such as C.I. Pigment Blue 18 (for example Alkali Blue V-5: 1).

For providing black color, there can be conceived an organic pigment for example an aniline black pigment such as BK-I (Aniline Black), an iron oxide pigment, or a carbon black pigment such as furnace black, lamp black, acetylene black or channel black.

Also for reproducing a gold, silver or copper color, there can be conceived the use of metal powder.

(Surface Treatment of Colorant)

A colorant to be employed in an inkjet recording ink is usually subjected to a surface treatment.

For surface treatment of the colorant, there can be employed a rosin treatment, a polymer treatment, a grafting treatment or a plasma treatment as described in “Ganryou Bunsan Gijutsu”, chapter 5, published by Gijutsu Jouhou Kyoukai.

“Rosin treatment” is a method of mechanically kneading pigment and rosin thereby treating the pigment surface with rosin, or a method of adding an alkaline aqueous solution of rosin to an aqueous slurry of pigment and then adding an alkali earth salt or an acid thereby precipitating a low-soluble salt or a free acid of rosin on the surface of pigment particles. In the rosin treatment, rosin is usually employed in an amount of several % to 20% of the pigment. This treatment is effective in (1) obtaining fine and highly transparent pigment by a crystal growth preventing effect for the pigment, (2) facilitating mechanical dispersion because of a decrease in the drying and aggregation of the particles, and (3) increasing a lipophilicity of the pigment surface thereby improving wetting to an oily vehicle, and is often employed in the field of printing inks.

“Grafting treatment” is to perform a grafting reaction of a functional group such as a hydroxyl group, a carboxyl group or an amino group, present on the surface of an inorganic particles such as carbon black, silica or titanium oxide, or an organic pigment with a polymer. A grafting reaction of polymer to a pigment surface can be performed for example by (1) a method of executing a polymerization of a vinyl monomer with a polymerization initiator in the presence of pigment particles, and terminating the growth of a polymer generated in the system by a functional group on the surface of the pigment particles, (2) a method of growing a graft chain from a polymerization initiating group introduced to the surface of pigment particles, or (3) a method of executing a polymer reaction between a functional group on the surface of the pigment particles and a terminal functional group of a polymer.

“Plasma treatment” is to modify the surface of the pigment particles by a low-temperature plasma or a thermal plasma. Examples of treatment of the pigment surface with a low-temperature plasma includes (1) a modification by an irradiation with a plasma of a non-polymerization gas such as oxygen or nitrogen, (2) a modification by forming a plasma polymerization film with a polymerizable gas, and (3) a modification by a plasma-initiated graft polymerization reaction by a two-step process, including a first stage of forming active species on the surface of a base material by a plasma irradiation and a second stage of contacting with a monomer after the irradiation and then executing a graft polymerization reaction.

For improving the dispersibility of the pigment, a following polymer treatment is preferable.

Representative methods of polymer treatment includes a chemical process utilizing an in-situ polymerization described in “Ganryou Bunsan Gijutsu”, p.99 and thereafter, published by Gijutsu Jouhou Kyoukai, a phase separation (coacervation) process, and a mechanical treatment process at the pigment dispersion.

The in-situ polymerization process includes a method of dispersing a system containing a pigment and a polymer and then performing a suspension polymerization, a method of dispersing a pigment in an aqueous system in the presence of a dispersant and performing a polymerization by adding a polar polymer, a vinylic polymer and a polyfunctional crosslinking polymer, and a method of a block polymerization of a monomer with a dispersed pigment and then performing a suspension polymerization or an emulsion polymerization thereby achieving a sufficient adsorption to the pigment.

The phase separation (coacervation) process is a method of dispersing a pigment in a polymer solution and lowers the solubility of the polymer by certain means thereby precipitating the polymer onto the pigment particles, and is featured in that polymers of a wider range can be adopted in comparison with the chemical process (in-situ polymerization process). A method of adding a non-soluble solvent to a resin solution in which a pigment is dispersed thereby precipitating the resin onto the pigment surface, and a method of finely dispersing a pigment in a solution of a water-soluble polymer or a water-soluble resin and then regulating a pH value thereby precipitating such polymer or resin onto the pigment surface are widely practiced in addition to the rosin treatment. A substance obtained by dispersing a pigment in an acidic solution of an acid-soluble nitrogen-containing acrylic resin and then elevating a pH value to insolubilize the polymer on the pigment surface is found effective in improving an aggregation resistance, a fluidity, a gloss and a coloring power in a paint or a printing ink.

The mechanical polymer treatment process is for example a method of mixing a polymer and a pigment with a pigment content of 5 to 95%, then kneading the mixture with a kneader or a three-roll mixer under heating and crushing the mixture for example with a pin mill. The mechanical polymer treatment process also includes a method called flushing resin treatment.

As the resin to be employed in the polymer treatment, any resin having a function of improving the dispersibility of the resin in a dispersion medium can be employed without restriction.

In order to be adsorbed on the colorant and be well dispersed in the dispersion medium, there is preferred a resin having a portion causing a solvation with a solvent, a portion showing little solvation and a polar group. Examples of a monomer causing a solvation with a solvent after polymerization includes lauryl methacrylate, stearyl methacrylate, 2-ethylhexyl methacrylate, and cetyl methacrylate. Examples of a monomer showing little solvation after polymerization includes methyl methacrylate, ethyl methacrylate, isopropyl methacrylate, styrene, and vinyltoluene. Examples of a monomer including a polar group includes a monomer having an acidic group such as acrylic acid, methacrylic acid, itaconic acid, fumaric acid, maleic acid, styrenesulfonic acid or an alkali salt thereof, and a monomer having a basic group such as dimethylaminoethyl methacrylate, diethylaminoethyl methacrylate, vinylpyridine, vinylpyrrolidine, vinylpiperidine, or vinyllactam.

Specific examples of the resin to be employed in the polymer treatment include a polymer and a copolymer of an olefin (such as polyethylene, polypropylene, polyisobutylene, an ethylene-vinyl acetate copolymer, an ethylene-acrylate copolymer, an ethylene-methacrylate copolymer, or an ethylene-methacrylic acid copolymer), a polymer and a copolymer of styrene or a derivative thereof (such as a butadiene-styrene copolymer, an isoprene-styrene copolymer, a styrene-methacrylate copolymer, or a styrene-acrylate copolymer), a polymer and a copolymer of an acrylate ester, a polymer and a copolymer of a methacrylate ester, a polymer and a copolymer of an itaconate diester, a maleic anhydride copolymer, a rosin resin, a hydrogenated rosin resin, a petroleum resin, a hydrogenated petroleum resin, a maleic acid resin, a terpene resin, a hydrogenated terpene resin, a chroman-indene resin, a cyclized rubber-methacrylate ester copolymer, and a cyclized rubber-acrylate ester copolymer.

In the invention, a proportion of the colorant and the resin employed in the polymer treatment is within a range of 95/5 to 5/95 in a colorant/resin weight ratio, preferably within a range of 80/20 to 10/90.

As the surface treated colorant, there can also be employed a commercially available processed pigment. An example of such commercially available processed pigment is a Microlith pigment manufactured by Ciba Specialty Chemicals Inc., and a preferred example is Microlith-T pigment formed by coating a pigment with a rosin ester resin.

(Dispersant)

In the wet dispersion step of the invention, the surface treated colorant is dispersed in fine particles in a dispersion medium.

In the dispersion step, a dispersant is preferably employed in order to disperse the surface treated colorant into fine particles and stabilize the dispersion in the dispersion medium.

A dispersant employable in the invention can be an ordinary dispersant for pigments, employed in such dispersant. There can be employed any dispersant for pigment, mutually soluble with the dispersion medium and capable of stably dispersing the pigment into fine particles.

Specific examples of the pigment dispersant include a sorbitan fatty acid ester (such as sorbitan monooleate, sorbitan monolaurate, sorbitan sesquioleate, or sorbitan trioleate), a polyoxyethylene sorbitan fatty acid ester (such as polyoxyethylene sorbitan monostearate or polyoxyethylene sorbitan monooleate), a polyethylene glycol fatty acid ester (such as polyethylene glycol monostearate or polyethylene glycol diisostearate), a polyoxyethylene alkylphenyl ether (such as polyoxyethylene nonylophenyl ether or polyoxyethylene octylphenyl ether), a nonoic surfactant such as an aliphatic diethanolamide, and a polymer dispersant, which is preferably a polymer compound with a molecular weight of 1,000 or higher, such as a styrene-maleic acid resin, a styrene-acryl resin, rosin, BYK-160, 162, 164, or 182 (urethane polymer compounds manufactured by Byk Chemie GmbH), EFKA-47 or LP-4050 (urethane dispersants manufactured by EFKA, Frankel & Kirchner GmbH), Solspers 24000 (polyester polymer compound manufactured by Zeneka Ltd.) or Solspers 17000 (aliphatic diethanolamide manufactured by Zeneka Ltd.).

The polymer dispersant for pigment further includes, in addition to the foregoing, a random copolymer containing a monomer showing a solvation with the solvent such as lauryl methacrylate, stearyl methacrylate, 2-ethylhexyl methacrylate or cetyl methacrylate, a monomer showing little solvation with the solvent such as methyl methacrylate, ethyl methacrylate, isopropyl methacrylate, styrene or vinyltoluene and a portion having a polar group, or a graft copolymer disclosed in JP-A No. 3-188469. The monomer containing a polar group can be a monomer having an acidic group such as acrylic acid, methacrylic acid, itaconic acid, fumaric acid, maleic acid, styrenesulfonic acid or an alkali salt thereof, and a monomer having a basic group such as dimethylaminoethyl methacrylate, diethylaminoethyl methacrylate, vinylpyridine, vinylpyrrolidine, vinylpiperidine, or vinyllactam. Also there can be employed a styrene-butadiene copolymer, or a block copolymer of styrene and a long-chain alkyl methacrylate disclosed in JP-A No. 60-10263, and a preferred dispersant for pigment is a graft copolymer disclosed in JP-A No. 3-188469.

An amount of the pigment dispersant is preferably 0.1 to 300 parts by weight with respect to 100 parts by weight of the pigment, and a sufficient pigment dispersing effect can be obtained within such range.

(Additives)

The inkjet recording ink of the present invention includes the dispersion medium, the colorant and the dispersant explained in the foregoing as basic constituents, but various additives may be added, if desirable, to the ink composition of the invention. Such additives may be arbitrarily selected and contained in the ink composition, according to an inkjet method, or a material and a structure of an inkjet discharging head, an ink supply portion and an ink circulating portion. For example, there can be employed additives described in Takeshi Amari, “Inkjet printer, Technology and Materials”, chapter 17, published by CMC Co. (1998).

Specific examples include a metal salt (metal being for example Na, K, Li, B, Al, Ti, Ca, Pb, Mn, Co, Zn, Mg, Ce, Ag, Zr, Cu, Fe or Be) of an aliphatic acid (for example a monocarboxylic acid or a polybasic acid with 6 to 32 carbon atoms, such as 2-ethylhexylic acid, dodecenylsuccinic acid, butylsuccinic acid, 2-ethylcaproic acid, lauric acid, palmitic acid, elaidic acid, linolenic acid, ricinolic acid, oleic acid, stearic acid, enanthic acid, naphthenic acid, ethylenediamine tetracetic acid, abietic acid, dehydroabietic acid, or hydrogenated rosin), a resin acid, an alkylphthalic acid, or an alkylsalicylic acid; a surface active compound (for example an organic phosphoric acid or a salt thereof such as a mono-, di- or tri-alkylphosphoric acid with an alkyl group of 3 to 18 carbon atoms), an organic sulfonic acid or a salt thereof such as a long-chain aliphatic sulfonic acid, a long-chain alkylbenzenesulfonic acid, a dialkylsulfosuccinic acid or a salt thereof, or an amphoteric surface active compound for example a phospholipid such as lecithin or cephalin), a surfactant or an aliphatic alcohol having an alkyl group containing a fluorine atom and/or a dialkylsiloxane group (for example a higher alcohol including a branched alkyl group with 9 to 20 carbon atoms, benzyl alcohol, phenethyl alcohol, or cyclohexyl alcohol); a polyhydric alcohol {for example an alkylene glycol with 2 to 18 carbon atoms (such as ethylene glycol, 1,2-propylene glycol, 1,3-propylene glycol, 1,4-butanediol, neopentyl glycol, 1,6-hexanediol or dodecanediol)}; an alkylene ether glycol with 4 to 1,000 carbon atoms (such as diethylene glycol, triethylene glycol, dipropylene glycol, polyethylene glycol, polypropylene glycol or polytetramethylene ether glycol); an alicyclic diol with 5 to 18 carbon atoms (such as 1,4-cyclohexane dimethanol, or hydrogenated bisphenol-A); a polyol for example an addition product of a bisphenol with 12 to 23 carbon atoms (such as bisphenol-A, bisphenol-F or bisphenol-S) with an alkylene oxide with 2 to 18 carbon atoms (such as ethylene oxide, propylene oxide, butylenes oxide or α-olefin oxide), glycerin, trimethylolethane, trimethylolpropane, pentaerythritol or solbitol; a 3 to 8 or higher hydric phenol (such as trisphenol PA, phenol novolac, or cresol novolac); an addition product of the aforementioned 3 or higher hydric polyphenol with an alkylene oxide with 2 to 18 carbon atoms (with 2 to 20 addition moles), an ether derivative of the aforementioned polyhydric alcohol (such as a polyglycol alkyl ether or an alkylaryl polyglycol ether), a fatty acid ester derivative of the polyhydric alcohol, an ether olate derivative of the polyhydric alcohol (such as ethylene glycol monoethyl acetate, diethylene glycol monobutyl acetate, propylene glycol monobutyl propiolate, or sorbitan monomethyl dioxalate), an alkylnaphthalene sulfonate, or an alkylaryl sulfonate, but additives is not limited to such examples.

An amount of the additives is preferably so regulated that the ink composition has a surface tension within a range of 15 to 60 mN/m (at 25° C.) and a viscosity within a range of 1.0 to 40 cP.

Also it is preferable to add a charge regulating agent in order to control a polarity of the ink particles and a charge amount thereof. The charge regulating agent is preferably a metal salt of an organic carboxylic acid such as zirconium naphthenate or zirconium octenate, an ammonium salt of an organic carboxylic acid such as tetramethylammonium stearate, a metal salt of an organic sulfonic acid such as sodium dodecylbenzenesulfonate or magnesium dioctylsulfosuccinate, an ammonium salt of an organic sulfonic acid such as tetrabutylammonium toluenesulfonate, a polymer having a carboxylic acid group in a side chain such as a styrene-maleic anhydride copolymer denatured with an amine and having a carboxylic acid group, a polymer having a carboxylic acid anion in a side chain such as a copolymer of stearyl methacrylate and tetramethylammonium methacrylate, a polymer having a nitrogen atom in a side chain such as a styrene-vinylpyridine copolymer, or a polymer having an ammonium group in a side chain such as a copolymer of butyl methacrylate and N-(2-methacryloyloxyethyl)-N,N,N-trimethyl ammonium tosylate. A particularly preferred charge control agent is an octadecene-octadecyl maleate hemiamide copolymer. A charge given to the particle may be a positive charge or a negative charge.

(Ink Producing Method)

<1>Preparation of Colorant Particles and Crushing Step

In the following, there will be given a detailed explanation on an exemplary embodiment of a producing method for the inkjet recording ink of the invention. In an embodiment of a producing method for the inkjet recording ink of the invention, colorant particles (colorant-resin particles) can be prepared by coating a colorant with a binder resin thereby forming a colored mixture (the melt-kneading step), crushing the colored mixture into colorant particles (the crushing step), and dispersing such colorant particles into fine particles in a dispersion medium (the wet dispersing step). At first there will be explained a step of coating the colorant with the binder resin, thereby obtaining a colored mixture. The color mixture is prepared for example by following methods:
(1) A method of melt-kneading a colorant and a binder resin by a mixing machine such as a roll mill, a Bambury mixer or a kneader at a temperature equal to or higher than a softening point of the binder resin, and crushing the mixture after cooling to obtain a colored mixture;
(2) A method of kneading a water-containing paste (wet cake) of a pigment with a resin or a resin solution by a flushing method thereby replacing water with the resin or the resin solution, and eliminating the water and the solvent under a reduced pressure to obtain a colored mixture.

The colored mixture thus obtained is finely crushed in a next crushing step. A sufficient crushing in this stage allows to obtain uniform particles within a short time in the next wet dispersion step. On the other hand, incase the crushing is insufficient and coarse particles are present, such coarse particles remain long without being dispersed, thereby resulting in a wide particle size distribution and requiring a long dispersing time.

In the crushing step, it is preferable to perform a rough crushing at first and then to perform a fine crushing. For rough crushing, there is generally employed a roll mill, a cutter mill or a hammer mill, by which the colored mixture is crushed to about 0.5 to 1 mm. An equipment for fine crushing can be of a high-speed rotation type, a ball mill type, a medium agitation type or a gas flow crushing type. The high-speed rotation type includes a disk mill type, a pin mill type, a screw mill type, and a centrifuge classifying mill; the ball mill type includes a rotary motion type, a vibration type, and a planet type; the medium agitation type includes a tower type, an agitation tank type, a communication pipe type; and an annular type; and the gas flow crushing type includes a gas flow suction type, a nozzle suction type, a collision member colliding type and a gas flow colliding type. Specific examples include Jet-O-mizer and a single track jet mill (FS-4) manufactured by Seishin Kigyo Co., a jet mill manufactured by Fuji Sangyo Co., a P-J-M ultrasonic jet crusher manufactured by Nippon Pneumatic Co., all of which are usable and by which the colored mixture is crushed to a size of about 5 to 300 μm.

Such finely crushed colored mixture is preferably further subjected to a classification. The methods of classification include a sieving classification, a dry gas flow classification and a forced vortex dry gas flow classification, and a specific example of the forced vortex dry gas flow classification equipment is Spedic Crushfier (SPC-250) manufactured by Seishin Kigyo Co. There is preferred a classification to a size of 10 to 100 μm by such classifier, more preferably 20 to 50 μm.

<2>Storage Step

In the present invention, in order to obtain a stable electroconductivity after an ink preparation to be explained later, a storage step is provided after the preparation of the colorant particles and the crushing step explained above. Any method of storage may be employed as long as the colorant particles is in contact with an environment of a preferred absolute humidity, but, in consideration of easy of handling, it is preferable to place the colorant particles in an open storage container and to maintain in direct contact with the environment of a preferred absolute humidity. For example, there can be employed a pillar-shaped storage container having a bottom area of 530 cm² and a volume of 180 L(liter) and open in the upper part.

An environment with which the colorant particles is in contact preferably has an absolute humidity within a range of 4 to 35 g/m³, more preferably 8 to 25 g/m³. In order to obtain at least an ink conductivity necessary for obtaining a satisfactory discharge property from a front end of the head and for avoiding unnecessary discharge other than the front end, there is preferred an absolute humidity of 4 g/m³ or higher. On the other hand, in order to maintain the conductivity at a value capable of achieving a sufficient concentrating property for avoiding a blotting or less, there is preferred an absolute humidity of 35 g/m³ or less.

A storage time is preferably 3 hours or longer, more preferably 24 hours or longer. A storage time of 3 hours or longer allows to obtain an electroconductivity necessary for the discharge property. Also a storage time of 24 hours or longer allows to sufficiently adapt to the absolute humidity of the external environment and to obtain an electroconductivity necessary for the discharge property, so that there is no upper limit in particular.

During the storage, a variation in the absolute humidity is preferably within a range of ±3 g/m³. Within such range, there can be achieved an improvement in the reproducibility of the ink conductivity in repetition.

In the environment with which the colorant particles is in contact, an atmospheric component other than water vapor is usually air or an inert gas, but it may be suitably selected according to the type of the ink.

The storage temperature is usually from 15 to 35° C., however, it may be suitably selected according to the type of the ink.

<3>Dispersion Step

In the following, there will be explained a dispersion step, in which the colorant particles, after the storage under the aforementioned conditions, is subjected to a wet dispersion in a dispersion medium with a dispersant. A dispersing equipment to be employed in the dispersion step is not particularly restricted and can be a commercially available wet dispersion equipment, such as a ball mill, a sand mill, or an attritor, and a closed type equipment is usually employed in order to avoid evaporation of a solvent. A sand mill is available in a vertical type or a horizontal type, and performs dispersion by rotating a shaft, equipped with a disk or pins, at a peripheral speed of 3 to 15 m/s. An ink composition can be prepared efficiently by serially connecting several continuous-type sand mills and changing a diameter of a dispersion medium according to the degree of dispersion. Also in case of dispersion of a pigment of a large particle size with a continuous-type sand mill, there is required a pre-dispersion, which can be performed for example with a disperser, a ball mill or a batch-type sand mill.

Specific examples of the horizontal sand mill include dyno mill, dyno mill ECM (manufacture by WAB AG., Switzerland), Perl mill DCP (manufactured by Drais AG, Germany), Agitator Mill (Netsch AG, Germany), Super Mill (Sussmeyer SA, Belgium), Coball Mill (Fryma AG., Switzerland), and Spike Mill (manufactured by Inoue Mfg. Inc.).

As a dispersion medium for a ball mill or a sand mill, various materials such as zirconia, titania, alumina, glass, steel or silicon nitride. A material of the medium is selected by a specific gravity and an abrasion resistance thereof, in consideration of a viscosity of the dispersion liquid and a level of pre-dispersion.

The medium is not particularly restricted in a size, and a diameter for example of about 0.1 to 10 mm can be utilized. In general, a larger medium provides a wider particle size distribution, and a smaller medium can achieve a dispersion to a smaller particle size. Also a fill rate of the medium is not particularly restricted, but is preferably within a range of 50 to 90%. The fill rate of the medium and the dispersing ability are closely correlated, and it is known that a higher fill rate improves the dispersion efficiency. In a horizontal type mill, being free from a locking phenomenon of the medium at the start-up in comparison with a vertical type mill, there is preferred a fill rate of 80 to 85% with respect to a vessel capacity.

The colorant particles in the dispersion medium, obtain in the dispersion step, have a volume-averaged diameter of 0.01 to 10 μm, more preferably 0.2 to 5 μm.

<4>Liquid Preparation Step

An ink liquid preparation step performs a dilution of a dispersion obtained in the dispersion step, and an addition of a charge regulating agent and the like thereby obtaining a final product.

A dispersion medium to be employed in the dilution can be same as that in the dispersion step. Also the charge regulating agent can be those described in the foregoing.

(Electrostatic Inkjet Recording Method)

In the following there will be explained an electrostatic inkjet recording method in which an inkjet recording ink, prepared according to the invention, can be advantageously employed.

The FIGURE is a view showing an example of a line-scan multi-channel inkjet head to be employed in the electrostatic inkjet recording method, and shows a cross section of a discharge electrode corresponding to a recording dot. In the FIGURE, an ink 100 is supplied from an ink circulating system 111 including a pump, through an ink supply system 112 connected to a head block 101, to a space between a head substrate 102 and a discharge electrode substrate 103, and is recovered to the ink circulating system 111 through an ink recovery system 113 formed in the head block 101. The discharge electrode substrate 103 is constituted of an insulating substrate 104 having a penetrating hole 107, and a discharge electrode 109 around the penetrating hole 107 and at a side of a recording medium. On the other hand, on the head substrate 102, a convex ink guide 108 is provided at an approximate center of the penetrating hole 107. The convex ink guide 108 is formed by an insulating member such as of a plastic resin or a ceramic material, and is provided with a row gap and a pitch same as those of the penetrating hole 107 so as to be positioned at the center thereof, and is supported on the head substrate 102 by a predetermined method. Each convex ink guide 108 has a shape of a flat plate of a constant thickness of which a tip portion is cut out into a triangular or trapezoidal form, and such tip portion constitutes an ink droplet flying position 110. Each convex ink guide 108 may have a slit-shaped groove from the tip portion, and such slit achieves a smooth ink supply to the ink droplet flying position 110 by a capillary phenomenon, thereby improving a recording frequency. Also the ink guide may be rendered electroconductive in an arbitrary surface thereof, and, in such case, the conductive portion is maintained in an electrically floating state, whereby an electric field can be formed in the ink flying position with a limited voltage application to the discharge electrode. Each convex ink guide 108 protrudes, from the corresponding penetrating hole 107, substantially vertically by a predetermined distance. A recording medium 121, or a recording paper, is positioned in a position opposed to the tip of the convex ink guide 108, and a counter electrode 122 serving also as platen for guiding the recording medium 121 is provided at a side thereof opposite to the head substrate 102. Also an electrophoresis electrode 140 is provided in a bottom portion of a space formed by the head substrate 102 and the discharge electrode substrate 103, and a predetermined voltage is applied thereto to cause an electrophoretic movement of the charged particles in the ink toward the discharge position of the ink guide, thereby improving a response of the discharge.

In the following there will be explained a specific example of the configuration of the discharge electrode substrate 103. Plural discharge electrodes are arranged in two arrays in a main scanning direction, and each discharge electrode is provided, at the center thereof, with a penetrating hole 107 around which each individual discharge electrode 109 is formed. The insulating substrate 104 is formed by a polyimide resin of a thickness of about 25 to 200 μm, while the discharge electrode 109 is formed by a copper foil of a thickness of about 10 to 100 μm, and the penetrating hole 107 has an internal diameter of about 150 to 250 μm.

In the following, there will be explained a recording operation of an inkjet recording apparatus of electrostatic type. In the following there will be explained, as an example, a case of employing a positively charged ink, but the present invention is not limited to such example. At the recording, the ink 100 supplied through an ink supply path 112 from the ink circulating system 111 is supplied from the penetrating hole 107 to the ink flying position 110 at the tip of the convex ink guide 108, and is recovered, in a part, through the ink recovery system 113 to the ink circulating system 111. The discharge electrode 109 is constantly given a bias voltage for example of +1.5 kV from a bias voltage source 123, and a pulse voltage for example of +500 V in an on-state is superposed to the discharge electrode 109 as a signal voltage corresponding to an image signal from a signal voltage source 124. Also in this operation, the electrophoresis electrode 140 is given a voltage of +1.8 kV. On the other hand, the counter electrode 122 at the back of the recording medium 121 is set at a ground voltage 0 V as illustrated. In a certain case, the bias voltage may be obtained by charging the side of the recording medium 121 for example at −1.5 kV. In such case, the counter electrode 122 is provided with an insulating layer on the surface thereof, and the recording medium is charged for example with a corona charger, a scorotron charger or a solid-state ion generator. The discharge electrode 109 is for example grounded and a pulse voltage for example of +500 V in an on-state is superposed to the discharge electrode 109 as a signal voltage corresponding to an image signal from a signal voltage source 124. Also the electrophoresis electrode 140 is given a voltage of +2.0 kV. Now, when the discharge electrode 109 is turned on (an application state of 500 V) and is given a voltage of 2 kV in total, namely the bias voltage of DC 1.5 kV superposed with the pulse voltage of 500 V, an ink droplet 115 flies out from the ink droplet flying position 110 at the tip of the convex ink guide 108, is attracted by the counter electrode 122 and flies toward the recording medium 121 thereby forming an image.

In order to precisely control the flying of the ink droplet and to improve the landing precision on the recording medium, measures are conceived such as providing an intermediate electrode between the discharge electrode and the recording medium or providing a guard electrode between the discharge electrodes for suppressing an interference of electric fields, and such measures may naturally be employed advantageously also in the present embodiment if necessary. Also a porous member may be provided between the head substrate 102 and the discharge electrode substrate 103, and, in such case, it is rendered possible to prevent an influence by a change in the internal ink pressure resulting for example from a movement of the inkjet recording head, and to achieve a prompt replenishment of the ink liquid into the penetrating hole 107 after the ink droplet discharge. Thus there can be attained a stable flight of the ink droplet 115 and a high-speed recording of a satisfactory image with a stable density on the recording medium 121.

### EXAMPLES

In the following, the present invention will be clarified further by examples, but the invention is not limited to such examples.

### Example 1

20 parts by weight of a blue pigment Linol Blue FG-7350 (Pigment Blue 15:3, manufactured by Toyo Ink Co.) and 40 parts by weight of a styrene/vinyltoluene/lauryl methacrylate/butyl acrylate/trimethylammonium methacrylate (anion p-toluenesulfonate) copolymer (weight ratio=25/27/2/27/18, weight-averaged molecular weight: 11,000) as a resin were crushed and mixed well in a Trio Blender, manufactured by Trio Science Ltd., and then subjected to a melt-kneading under heating in a desk-top kneader PBV-0.1, manufactured by Irie Shokai Co. for 120 minutes at 85° C. to provide a pigment-resin mixture (colored mixture). The pigment-resin mixture mentioned above was crushed for 30 seconds in a Trio Blender to obtain a coarse crushed substance of about 1 mm or less. It was then crushed for 30 seconds in a sample mill SD-M10 manufactured by Kyoritsu Riko Co. In an observation under an optical microscope, the crushed substance was finely crushed pigment-resin particles (colorant-resin particles) of about 10 to 200 μm. The fine crushed substance was stored for 24 hours at 20° C. in an environment of an absolute humidity of 5 g/m³. Subsequently, 30 parts by weight of the fine crushed substance, 32.5 parts by weight of Isopar-G, 37.5 parts by weight of a 20 weight % solution of a following pigment dispersant (D-1), prepared by dissolving in Isopar-G under heating, and 400 parts by weight of glass beads of a diameter of about 3 mm were charged in a 500-ml mayonnaise bottle and subjected to a preliminary dispersion for 30 minutes on a paint shaker, manufactured by Toyo Seiki Seisakusho Ltd. After the glass beads were removed, the dispersion was dispersed with glass beads of a diameter of 0.5 to 0.71 mm in a dyno mill KDL (manufactured by Shin-maru Enterprises Ltd., vessel capacity: 0.3 liters) for 2 hours at 2,000 rpm at a liquid temperature controlled at 30° C. with a thermostat NESLABRTE7, manufactured by MS Kiki Co., and further dispersed for 1 hour at 40° C. The glass beads were removed from the obtained dispersion, and 30 parts by weight of Isopar-G and 0.13 parts by weight of an octadecene-octadecyl maleate hemiamide copolymer as the charge regulating agent were added to obtain an ink composition of a particle concentration of 7 wt. %. The pigment-resin particles in the ink had a volume-averaged diameter of 0.95 μm in a measurement with an ultracentrifuge automatic particle size distribution measuring apparatus CAPA 700, manufactured by Horiba Ltd.
pigment dispersant (D-1) 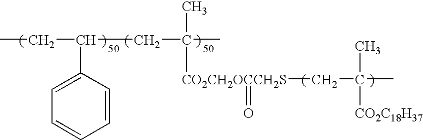
The copolymerization ratio is a weight ratio.

The ink composition had a viscosity of 1.5 mpa·sec (measured with an E-type viscosimeter at 20° C.), a surface tension of 23 mN/m (measured at 20° C. with an automatic surface tension meter, manufactured by Kyowa Kaimen Kagaku Co.) and a specific conductivity of the entire ink of 750 pS/cm (measured with an LCR meter AG-4311, manufactured by Ando Electric Co.). The specific conductivity was measured with the LCR and an electrode for liquid LP-05 (manufactured by Kawaguchi Denki Seisakusho Co.) under conditions of a voltage of 5 V and a frequency of 1 kHz.

Then the ink composition was employed in, as an inkjet recording apparatus, an electrostatic inkjet head of a structure shown in the figure with 100 dpi and 64 channels. After a coated recording paper was subjected to a dust elimination on the surface by a pump suction and the discharge head was brought to a printing position close to the coated recording paper and a recording was conducted by discharging the ink with a resolution of 600 dpi to obtain a dot image of a satisfactory density without a blotting in the recorded image. Also the discharge property from the inkjet recording head was stable and an unnecessary discharge from other portions than the discharge portion was completely absent.

### Comparative Example 1

An ink was prepared in the same manner as in Example 1, except that the storage conditions for the finely crushed pigment-resin particles were changed to a temperature of 15° C. and an absolute humidity of 1.2 g/m³. The ink had a viscosity of 1.5 mPa·sec, a surface tension of 23 mN/m and a specific conductivity of the entire ink of 550 pS/cm. In an evaluation of the discharge property in the same manner as in Example 1, no particles were discharged at all.

### Examples 2-4, Comparative Examples 2-3

Inks were prepared in the same manner as in Example 1, except that the storage conditions for the finely crushed pigment-resin particles were changed, and the electroconductivity of the ink and the discharge property were investigated. All the inks had a particle size of 0.95 μm, a viscosity of 1.5 mPa·sec and a surface tension of 23 mN/m.

Results are shown in Table 1.

TABLE 1

| | absolute | specific | |
|---|---|---|---|
| | humidity | conductivity | discharge |
| | (g/cm³) | (pS/cm) | property |
| Example 1 | 5 | 750 | +(stable |
| | | | discharge) |
| Example 2 | 12 | 800 | + |
| Example 3 | 24 | 820 | + |
| Example 4 | 35 | 850 | + |
| Comparative | 1.2 | 550 | −(no |
| Example 1 | | | discharge) |
| Comparative | 2.5 | 600 | ±(occasional |
| Example 2 | | | discharges) |
| Comparative | 42 | 1,000 | −(image |
| Example 3 | | | blotting) |

As will be apparent from Table 1, a satisfactory discharge property was obtained in Examples 1 to 4 within the range of the absolute humidity of the present invention.

### Example 5

Inks (n=1 to 3) were prepared in the same manner as in Example 1, except that the finely crushed pigment-resin particles were stored for 24 hours in a storage environment of a temperature fixed at 23° C. and an absolute humidity of 18±3 (15, 18 and 21) g/m³, and an ink conductivity and a discharge property were investigated. All the inks had a particle size of 0.95 μm, a viscosity of 1.5 mP·sec and a surface tension of 23 mN/m.

Results are shown in Table 2.

TABLE 2

| | absolute | specific | |
|---|---|---|---|
| | humidity | conductivity | discharge |
| | (g/cm³) | (pS/cm) | property |
| n = 1 | 15 | 810 | + |
| n = 2 | 18 | 820 | + |
| n = 3 | 21 | 820 | + |

As will be apparent from Table 2, within the range of ±3 g/cm³, the electroconductivity showed little fluctuation and satisfactory discharge property could be obtained.

The present invention has been explained in detail and by referring to specific embodiments, but it will be apparent for those skilled in the art that various modification and alterations can be added within the scope and spirit of the invention.

The entire disclosure of each and every foreign patent application from which the benefit of foreign priority has been claimed in the present application is incorporated herein by reference, as if fully set forth herein.

What is claimed is:

1. A method for producing an ink for inkjet recording, comprising:
melt-kneading a resin and a colorant to provide a colored mixture;
crushing the colored mixture to provide colorant-resin particles; and
wet dispersing the colorant-resin particles in a dispersion medium,
wherein the method further comprises storing the colorant-resin particles in an external environment having an absolute humidity of 4 to 35 g/m³ before the wet dispersing of the colorant-resin particles.

2. The method for producing an ink for inkjet recording according to claim 1, wherein, in the storing of the colorant-resin particles, the external environment has a variation of the absolute humidity within a range of ±3 g/m³ and the colorant resin particles are stored for at least 3 hours.
